(19) United States
(12) Patent Application Publication
(10) Pub. No.: US 2025/0293385 A1
(43) Pub. Date: Sep. 18, 2025

(54) BATTERY CELL AND BATTERY MODULE INCLUDING THE SAME

(71) Applicant: SAMSUNG SDI CO., LTD., Yongin-si (KR)

(72) Inventors: Gang Yul KIM, Suwon-si (KR); Tae Ho SUH, Suwon-si (KR); Kyung Min PARK, Suwon-si (KR); Jun Ho LEE, Suwon-si (KR); Ji Won JUNG, Suwon-si (KR); Jung Heon KIM, Suwon-si (KR); Ji Seon HAN, Suwon-si (KR); Kil Yong JUNG, Suwon-si (KR); Hee Youn WON, Suwon-si (KR); So Ra LEE, Suwon-si (KR); Sung Hyun JEON, Suwon-si (KR); Jang Woong BAE, Suwon-si (KR)

(21) Appl. No.: 18/825,880

(22) Filed: Sep. 5, 2024

(30) Foreign Application Priority Data
Mar. 12, 2024 (KR) 10-2024-0034423

(51) Int. Cl. H01M 50/367; H01M 50/16; H01M 50/342; H01M 50/383

(52) U.S. Cl. CPC H01M 50/367; H01M 50/16; H01M 50/3425; H01M 50/383

(57) ABSTRACT

A battery cell includes: an electrode assembly; a cell case accommodating the electrode assembly; a cap plate coupled to the cell case and having a vent hole; a vent plate in the vent hole and configured to be opened or closed in response to an internal pressure of the cell case; a blocking member facing the cap plate and covering the vent plate; and a fixing member fixing the blocking member to the cell case or the cap plate.

### CROSS-REFERENCE TO RELATED APPLICATION

The present application claims priority to and the benefit of Korean Patent Application No. 10-2024-0034423, filed on Mar. 12, 2024, in the Korean Intellectual Property Office, the entire disclosure of which is incorporated herein by reference.

### BACKGROUND

### 1. Field

Aspects of some embodiments of the present disclosure relate to a battery cell and a battery module including the same.

### 2. Description of the Related Art

Unlike primary batteries that generally cannot be recharged, secondary batteries are batteries that can be repeatedly charged and discharged. Low-capacity secondary batteries may be used in small portable electronic devices such as smartphones, feature phones, laptop computers, digital cameras, and camcorders, and high-capacity secondary batteries are widely used as power storage batteries and power sources for driving motors in hybrid vehicles, electric vehicles, and the like. Such a secondary battery includes an electrode assembly including a positive electrode and a negative electrode, a case for accommodating the same, and an electrode terminal connected to the electrode assembly.

Secondary batteries may be used as battery modules or battery packs formed of a plurality of unit battery cells connected in series and/or parallel to provide high energy density. A battery module or battery pack may be formed by connecting electrode terminals of a plurality of unit cells to each other to meet the required amount of power and, for example, to implement a high-power secondary battery for an electric vehicle.

The above information disclosed in this Background section is only for enhancement of understanding of the background and therefore the information discussed in this Background section does not necessarily constitute prior art.

### SUMMARY

Aspects of some embodiments according to the present disclosure include a battery cell capable of preventing or reducing chain ignition of battery cells, and a battery module including the same.

These and other aspects and features of embodiments according to the present disclosure will be described in or will be apparent from the following description of some embodiments of the present disclosure.

According to some embodiments of the present disclosure, there is provided a battery cell including an electrode assembly, a cell case configured to accommodate the electrode assembly, a cap plate coupled to the cell case and having a vent hole, a vent plate installed in the vent hole and opened or closed in response to an internal pressure of the cell case, a blocking member facing the cap plate and configured to cover the vent plate, and a fixing member configured to fix the blocking member to the cell case or the cap plate.

According to some embodiments, the blocking member may include a first body seated on the cap plate, a capsule protruding from the first body and facing the vent plate, a blocking material inside the capsule, and a second body facing the first body and configured to seal the capsule.

According to some embodiments, the first body and the second body may be joined to each other along a joint line to surround an opening of the capsule.

According to some embodiments, the blocking material may be injected into the capsule in a liquid state and then cured.

According to some embodiments, the blocking material may include at least one selected from silicone, epoxy, and polyurethane.

According to some embodiments, the capsule may be inserted into the vent hole.

According to some embodiments, an edge of the capsule may be curved to have a certain (e.g., set or predetermined) curvature.

According to some embodiments, the capsule may be in contact with the vent plate.

According to some embodiments, the vent plate may include a fracture portion which protrudes toward the vent hole and is fractured as the internal pressure of the cell case rises to a set pressure or more, and the capsule may include a groove into which the fracture portion is inserted.

According to some embodiments, the blocking member may further include an extension portion extending from the first body or the second body.

According to some embodiments, the extension portion may be provided as a pair of extension portions, and the pair of extension portions may be symmetrically arranged at both sides of the first body or the second body.

According to some embodiments, the extension portion may face the cap plate, and the fixing member may include a cap sheet between the extension portion and the cap plate and having both surfaces fixed to the extension portion and the cap plate, respectively.

According to some embodiments, the extension portion may face the cell case, and the fixing member may include a case sheet between the extension portion and the cell case and having both surfaces fixed to the extension portion and the cell case, respectively.

According to some embodiments, the extension portion may intersect the first body and the second body.

According to some embodiments of the present disclosure, there is provided a module including a housing, and one or more battery cells inside the housing, wherein the battery cell includes an electrode assembly, a cell case configured to accommodate the electrode assembly, a cap plate coupled to the cell case and having a vent hole, a vent plate installed in the vent hole and opened or closed in response to an internal pressure of the cell case, a blocking member facing the cap plate and configured to cover the vent plate, and a fixing member configured to fix the blocking member to the cell case or the cap plate.

### BRIEF DESCRIPTION OF THE DRAWINGS

The drawings attached to this specification illustrate some embodiments of the present disclosure, and further describe aspects and features of embodiments according to the present disclosure together with the detailed description of the present disclosure. However, embodiments according to the present disclosure should not be construed as being limited to the drawings:

FIG. 1 is a schematic perspective view illustrating a configuration of a battery module according to some embodiments of the present disclosure;

FIG. 2 is a schematic perspective view illustrating a configuration of a battery cell according to some embodiments of the present disclosure;

FIG. 3 is a schematic plan view illustrating the configuration of the battery cell according to some embodiments of the present disclosure;

FIG. 4 is a schematic cross-sectional view illustrating the configuration of the battery cell according to some embodiments of the present disclosure;

FIG. 5 is a schematic cross-sectional view illustrating a configuration of a vent plate according to some embodiments of the present disclosure;

FIG. 6 is a schematic plan view illustrating the configuration of the vent plate according to some embodiments of the present disclosure;

FIG. 7 is a schematic perspective view illustrating a configuration of a blocking member and a fixing member according to some embodiments of the present disclosure;

FIG. 8 is a perspective view illustrating the configuration of the blocking member and the fixing member according to some embodiments of the present disclosure from a viewpoint different from that of FIG. 7;

FIG. 9 is a schematic plan view illustrating the configuration of the blocking member and the fixing member according to some embodiments of the present disclosure;

FIG. 10 is a schematic exploded perspective view illustrating the configuration of the blocking member and the fixing member according to some embodiments of the present disclosure;

FIG. 11 is an exploded perspective view illustrating the configuration of the blocking member and the fixing member according to some embodiments of the present disclosure from a viewpoint different from that of FIG. 10;

FIG. 12 is a schematic view illustrating a contact state between a capsule and the vent plate according to some embodiments of the present disclosure;

FIG. 13 is a schematic perspective view illustrating a configuration of a battery module according to some embodiments of the present disclosure;

FIG. 14 is a schematic perspective view illustrating a configuration of a battery cell according to some embodiments of the present disclosure;

FIG. 15 is a schematic plan view illustrating the configuration of the battery cell according to some embodiments of the present disclosure;

FIG. 16 is a schematic perspective view illustrating a configuration of a blocking member and a fixing member according to some embodiments of the present disclosure;

FIG. 17 is a perspective view illustrating the configuration of the blocking member and the fixing member according to some embodiments of the present disclosure from a viewpoint different from that of FIG. 16;

FIG. 18 is a schematic exploded perspective view illustrating the configuration of the blocking member and the fixing member according to some embodiments of the present disclosure; and

FIG. 19 is an exploded perspective view illustrating the configuration of the blocking member and the fixing member according to some embodiments of the present disclosure from a viewpoint different from that of FIG. 18.

### DETAILED DESCRIPTION

Herein, aspects of some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

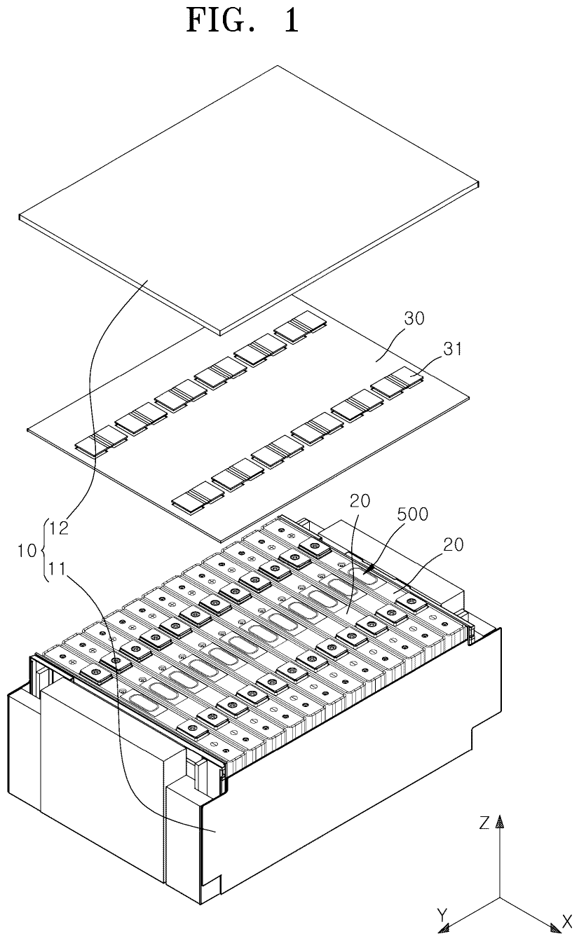

FIG. 1 is a schematic perspective view illustrating a configuration of a battery module according to some embodiments of the present disclosure.

Referring to FIG. 1, the battery module according to some embodiments may include a housing 10 and a battery cell 20.

The housing 10 may function as a component that supports the battery cell 20 and protects the battery cell 20 from external shocks and foreign materials. The housing 10 may provide a space for accommodating the battery cell 20 therein.

The housing 10 may include a housing body 11 and a housing cover 12.

The housing body 11 may be formed to have a hollow box shape with an open one side. For example, the open side of the housing body 11 may be arranged to face upward in FIG. 1. A cross-sectional shape of the housing body 11 is not limited to a quadrangular shape shown in FIG. 1 and may be designed to be changed into various shapes such as a polygonal shape, a circular shape, and an oval shape.

The housing cover 12 may be coupled to the housing body 11 and may seal an internal space of the housing body 11. As an example, the housing cover 12 may be formed to have an approximately plate shape. The housing cover 12 may be arranged to face the open side of the housing body 11, for example, an upper surface of the housing body 11. The housing cover 12 may be fixed to the housing body 11 through various types of coupling methods including bolting, welding, fitting, and the like.

The battery cell 20 may function as a unit structure that stores and supplies power in and from the battery module. The battery cell 20 may be located inside the housing 10.

One or more battery cells 20 may be provided. Although an example in which a plurality of battery cells 20 are provided is shown in FIG. 1, embodiments according to the present disclosure are not limited thereto, and one battery cell 20 may also be provided.

When the plurality of battery cells 20 are provided, the plurality of battery cells 20 may be arranged in a plurality of columns inside the housing 10. As an example, the plurality of battery cells 20 may be arranged in a plurality of columns in a longitudinal direction of the housing 10 (Y-axis direction in FIG. 1). However, the arrangement form of the plurality of battery cells 20 is not limited thereto. The plurality of battery cells 20 may be arranged in a plurality of columns in a width direction of the housing 10 (X-axis direction in FIG. 1) or may be arranged in a plurality of columns in the longitudinal direction and the width direction of the housing 10.

Hereinafter, an example in which the battery cell 20 is a prismatic lithium ion secondary will be described. However, embodiments according to the present disclosure are not limited thereto, and the battery cell 20 may be a lithium polymer battery or a cylindrical battery.

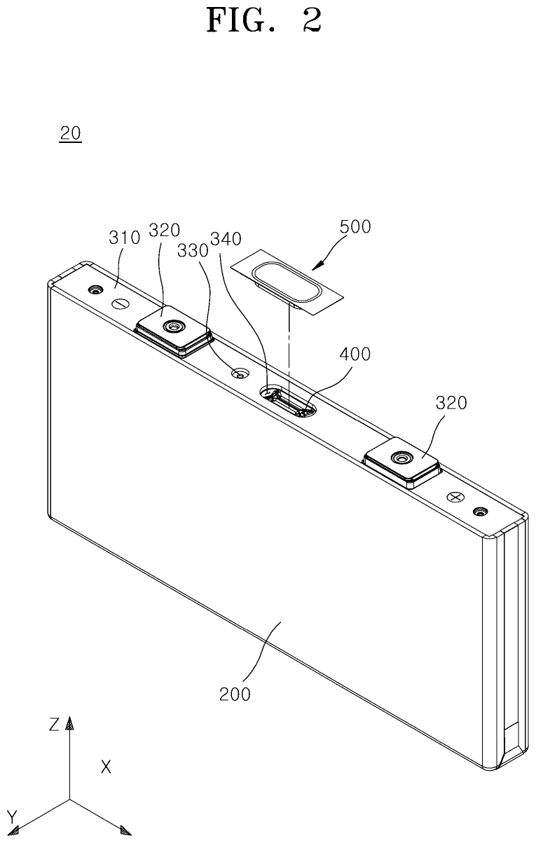

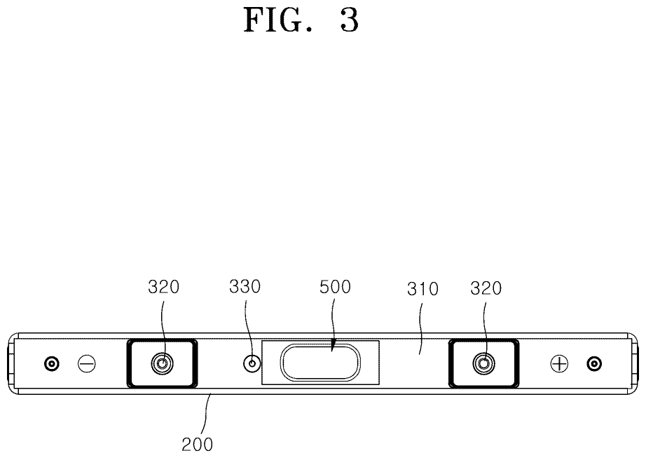

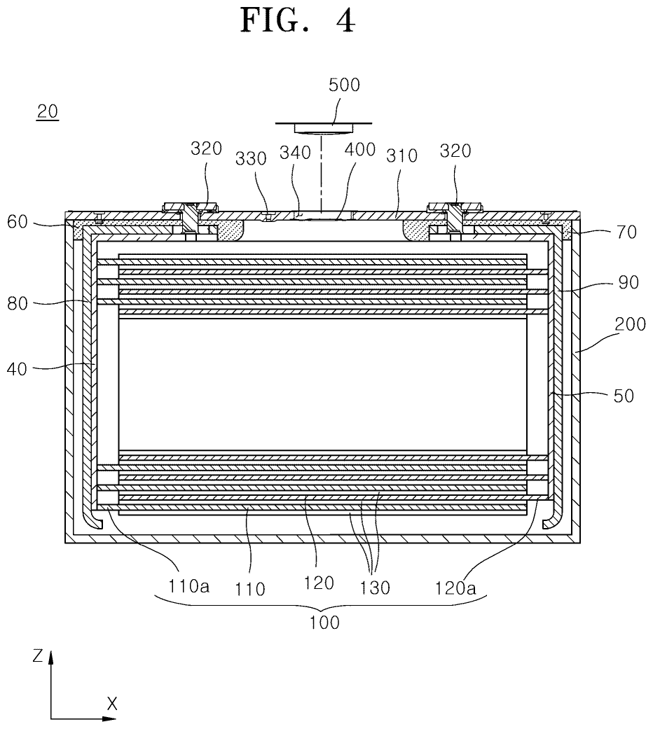

FIG. 2 is a schematic perspective view illustrating a configuration of the battery cell according to some embodiments of the present disclosure. FIG. 3 is a schematic plan view illustrating the configuration of the battery cell according to some embodiments of the present disclosure. FIG. 4 is a schematic cross-sectional view illustrating the configuration of the battery cell according to some embodiments of the present disclosure.

Referring to FIGS. 2 to 4, the battery cell 20 includes an electrode assembly 100, a cell case 200, a cap plate 310, a vent plate 400, a blocking member 500, and a fixing member 600.

The electrode assembly 100 may include a separator 130 located between a positive electrode 110 and a negative electrode 120.

The positive electrode 110 and the negative electrode 120 may include coated portions which are areas in which an active material is applied on a current collector made of thin metal foil, and uncoated portions 110a and 120a which are areas uncoated with the active material.

The electrode assembly 100 may be formed in the form of a jelly roll in which the separator 130, which is an insulator, is interposed between the positive electrode 110 and the negative electrode 120, and then the separator 130, the positive electrode 110, and the negative electrode 120 are wound. However, embodiments according to the present disclosure are not limited thereto, and the electrode assembly 100 may have a stack structure in which the positive electrode 110 and the negative electrode 120, which each includes a plurality of sheets, are alternately stacked with the separator 130 interposed therebetween.

The electrode assembly 100 may be formed singly or may be provided as a plurality of electrode assemblies 100.

The cell case 200 may form the overall exterior of the battery cell 20. The cell case 200 may accommodate the electrode assembly 100 therein. As an example, the cell case 200 may be formed to have a rectangular parallelepiped shape with an open one surface. The open surface of the cell case 200 may be arranged to vertically face the housing cover 12 inside the housing 10.

The cell case 200 may include a conductive metal material such as aluminum, an aluminum alloy, or a nickel-plated steel.

The cap plate 310 may be coupled to the cell case 200 and may seal the cell case 200. As an example, the cap plate 310 may be formed to have a plate shape. The cap plate 310 may be located on the cell case 200 to cover an open side of the cell case 200. The cap plate 310 may be coupled to the cell case 200 through various types of coupling methods including welding, bolting, fitting, and the like. The cap plate 310 may be made of a conductive material including at least one selected from aluminum and an aluminum alloy.

The cap plate 310 may include a terminal 320.

The terminal 320 may be installed to pass though the cap plate 310 and protrude to the outside of the cap plate 310. An outer peripheral surface of an upper pillar of the terminal 320 may be threaded to be fixed to the cap plate 310 through a nut. However, embodiments according to the present disclosure are not limited thereto, and the terminal 320 may have a rivet structure to be riveted or may be welded and coupled to the cap plate 310.

The terminal 320 protruding to the outside of the cap plate 310 may be provided as a pair of terminals 320. The pair of terminals 320 may be individually connected to the positive electrode 110 and the negative electrode 120 of the electrode assembly 100. Accordingly, the pair of terminals 320 may each function as one of a positive terminal and a negative terminal of the battery cell 20.

As an example, the terminals 320 may be electrically connected to current collectors including first and second current collectors 40 and 50 (hereinafter referred to as positive and negative electrode current collectors) joined to a positive electrode uncoated portion 110a and a negative electrode uncoated portion 120a through welding. For example, the pair of terminals 320 may each be connected to one of the positive and negative current collectors 40 and 50 through welding. However, embodiments according to the present disclosure are not limited thereto, and the terminals 320 and the positive and negative current collectors 40 and 50 may be formed by being integrally coupled.

The cap plate 310 may further include an electrolyte injection port 330 in which a sealing stopper may be installed.

The cap plate 310 may further include a vent hole 340.

The vent hole 340 may be formed to have the shape of a hole passing through both surfaces of the cap plate 310. The vent hole 340 may function as a component that provides a path through which flames, gases, smoke, or the like generated inside the cell case 200 are discharged from the battery cell 20 during thermal runaway of the battery cell 20. A lower side of the vent hole 340 may be connected to an internal space of the cell case 200. An upper side of the vent hole 340 may be connected to an external space of the cap plate 310. A cross-sectional shape of the vent hole 340 may be designed to be changed into various shapes such as an oval shape, a circular shape, and a polygonal shape.

The vent plate 400 may be opened or closed in response to a change in internal pressure of the cell case 200. That is, the vent plate 400 may remain closed to seal the cell case 200 during a normal operation of the battery cell 20. The vent plate 400 may be opened as the internal pressure of the cell case 200 rises to a set magnitude or more due to overcharging of the battery cell 20 or an outbreak of fire and may discharge flames, gases, smoke, or the like generated from the inside of the cell case 200 to the outside of the cell case 200.

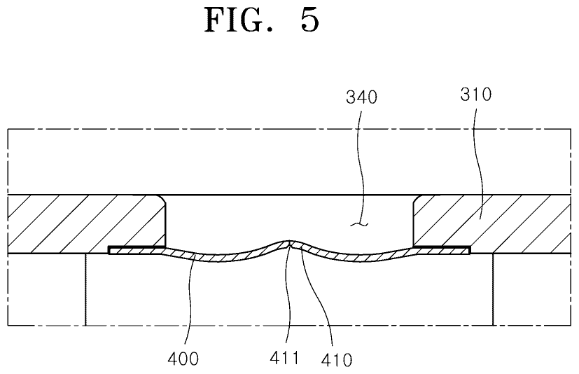

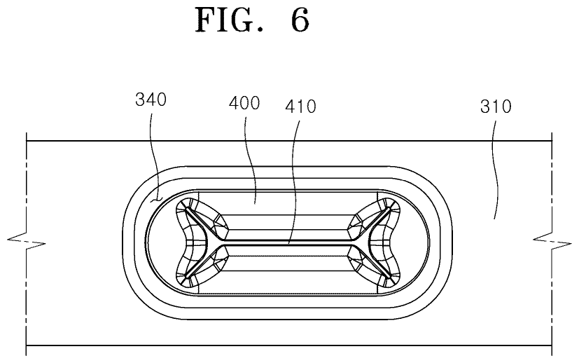

FIG. 5 is a schematic cross-sectional view illustrating a configuration of the vent plate according to some embodiments of the present disclosure. FIG. 6 is a schematic plan view illustrating the configuration of the vent plate according to some embodiments of the present disclosure.

Referring to FIGS. 5 and 6, the vent plate 400 according to some embodiments may be formed to have a plate shape. The vent plate 400 may be arranged to face a lower end of the vent hole 340. An area of the vent plate 400 may be larger than a cross-sectional area of the vent hole 340. An upper surface of the vent plate 400 may be coupled to a lower surface of the cap plate 310 through various types of coupling methods including welding, bolting, fitting, and the like.

The vent plate 400 may include a fracture portion 410.

The fracture portion 410 may form a partial exterior of the vent plate 400. The fracture portion 410 may be fractured as the internal pressure of the cell case 200 rises to a set pressure or more and thus may open the vent plate 400.

As an example, the fracture portion 410 may protrude from the upper surface of the vent plate 400 toward the vent hole 340. The fracture portion 410 may be formed such that a width becomes narrower toward an upper end portion. The fracture portion 410 may be cut to both sides with respect to the upper end portion by pressure applied from the internal space of the cell case 200. A notch 411 may be formed in an inner surface of the upper end portion of the fracture portion 410 to induce a fracture action of the fracture portion 410. A cross-sectional shape of the fracture portion 410 is not limited to the shape shown in FIG. 5 and may be formed to form various patterns on the vent plate 400.

An insulating member may be installed between the electrode assembly 100 and the cap plate 310. The insulating member may include first and second lower insulating members 60 and 70, and each of the first and second lower insulating members 60 and 70 may be installed between the electrode assembly 100 and the cap plate 310.

One end portion of a separation member that may be installed to face one side surface of the electrode assembly 100 may be installed between the insulating member and the terminal 320.

The separation member may include first and second separation members 80 and 90.

One end portion of each of the first and second separation members 80 and 90 that may be installed to face one side surface of the electrode assembly 100 may be installed between the first and second lower insulating members 60 and 70 and the pair of terminals 320.

The terminals 320 welded and coupled to the positive and negative current collectors 40 and 50 may be coupled to one end portions of the first and second lower insulating members 60 and 70 and the first and second separation members 80 and 90.

The blocking member 500 may be arranged to face the cap plate 310 and may cover the vent plate 400.

The blocking member 500 may function as a component that blocks flames, gases, smoke, or the like generated outside the battery cell 20 from flowing into the vent hole 340 or coming into direct contact with the vent plate 400. Accordingly, when a fire occurs in any one of the battery cells 20, the blocking member 500 may prevent or reduce chain ignition of the plurality of battery cells 20 due to flames, gases, smoke, or the like flowing into the vent holes 340 of adjacent battery cells 20.

The blocking member 500 may be separated from the cap plate 310 by flames and heat and pressure of gas generated inside the battery cell 20. Accordingly, in the event of thermal runaway of any one battery cell 20, the blocking member 500 may guide flames, gases, or the like generated from the battery cell 20 to be smoothly discharged to the outside.

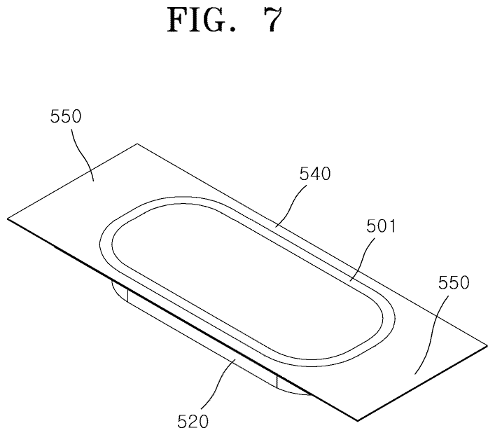

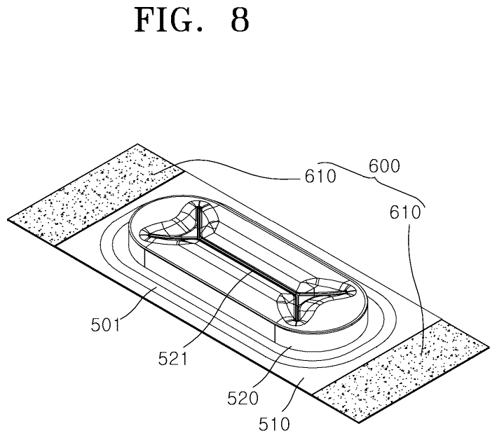

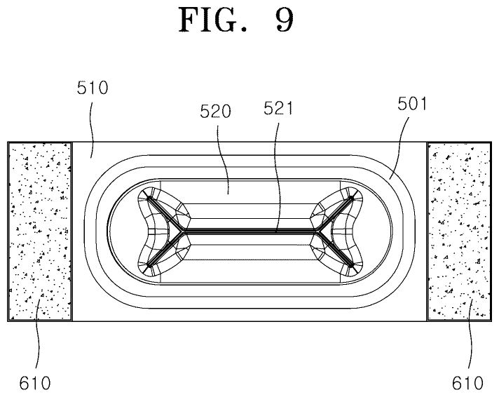

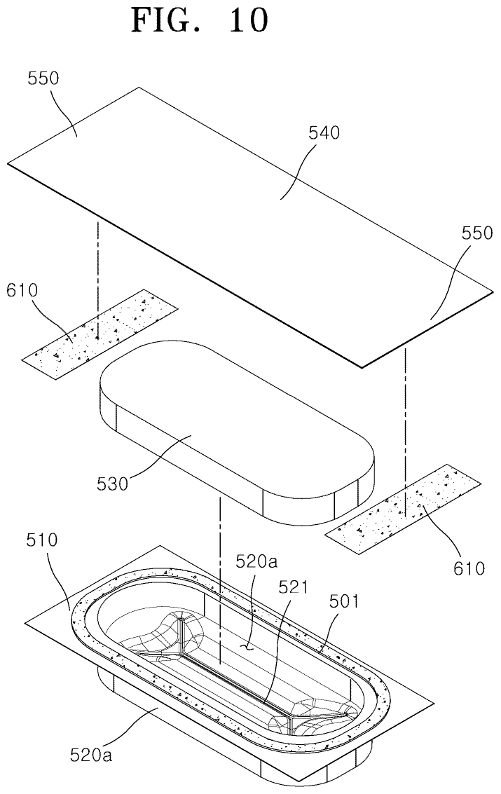

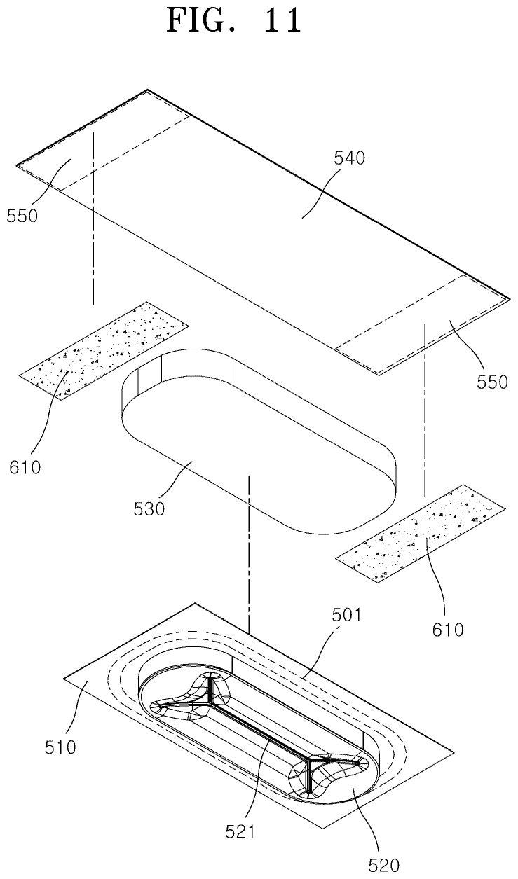

FIG. 7 is a schematic perspective view illustrating a configuration of the blocking member and the fixing member according to some embodiments of the present disclosure. FIG. 8 is a perspective view illustrating the configuration of the blocking member and the fixing member according to some embodiments of the present disclosure from a viewpoint different from that of FIG. 7. FIG. 9 is a schematic plan view illustrating the configuration of the blocking member and the fixing member according to some embodiments of the present disclosure. FIG. 10 is a schematic exploded perspective view illustrating the configuration of the blocking member and the fixing member according to some embodiments of the present disclosure. FIG. 11 is an exploded perspective view illustrating the configuration of the blocking member and the fixing member according to some embodiments of the present disclosure from a viewpoint different from that of FIG. 10.

Referring to FIGS. 1 to 11, the blocking member 500 may include a first body 510, a capsule 520, a blocking material 530, and a second body 540.

The first body 510 may form one side exterior of the blocking member 500 and may entirely support the capsule 520, the blocking material 530, and the second body 540.

As an example, the first body 510 may be formed to have a plate shape. An area of the first body 510 may be larger than the cross-sectional area of the vent hole 340. Accordingly, a central portion of the first body 510 may be arranged to face an upper end of the vent hole 340, and an edge of the first body 510 may be seated on an upper surface of the cap plate 310. The first body 510 may be made of a polymer compound material.

The capsule 520 may protrude from the first body 510 toward the vent hole 340 and may be arranged to face the vent plate 400.

As an example, the capsule 520 may protrude downward from a lower surface of the central portion of the first body 510. An internal space of the capsule 520 may be formed to be empty. An opening 520a may be formed in an upper side of the capsule 520 to pass through an upper surface of the first body 510 and open the internal space of the capsule 520. The capsule 520 may be made of a polymer compound material.

As the first body 510 is seated on the upper surface of the cap plate 310, the capsule 520 may be inserted into the vent hole 340. A cross-sectional area of the capsule 520 may be smaller than or equal to the cross-sectional area of the vent hole 340. A cross-sectional shape of the capsule 520 may be formed to be the same as the cross-sectional shape of the vent hole 340. An edge of a lower end portion of the capsule 520 may be formed to be curved to have a curvature (e.g., a certain, set, or predetermined curvature). That is, the edge of the lower end portion of the capsule 520 may have a curved shape. Accordingly, the capsule 520 may be more smoothly inserted into the vent hole 340.

A lower surface of the capsule 520 may be in contact with the vent plate 400.

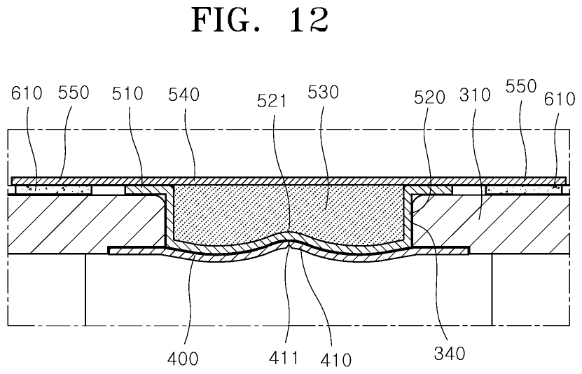

FIG. 12 is a schematic view illustrating a contact state between the capsule and the vent plate according to some embodiments of the present disclosure.

Referring to FIGS. 1 to 12, a groove 521 may be formed in an area of the lower surface of the capsule 520 which faces the fracture portion 410 of the vent plate 400.

The groove 521 may be formed to have a groove shape that is formed to be concavely recessed upward from the lower surface of the capsule 520. A cross-sectional shape of the groove 521 may be formed to correspond to the cross-sectional shape of the fracture portion 410. Since the lower surface of the capsule 520 is in contact with the vent plate 400, the fracture portion 410 may be inserted into the groove 521. An outer surface of the fracture portion 410 may be in close contact with an inner surface of the groove 521. Accordingly, the groove 521 expands a contact area between the capsule 520 and the vent plate 400, thereby preventing or reducing instances of the capsule 520 being separated from the vent hole 340 due to external vibrations or the like.

The blocking material 530 may be located inside the capsule 520. The blocking material 530 may function as a component that physically blocks foreign materials flowing from the outside of the battery cell 20 and reinforces the heat resistance performance of the blocking member 500.

The blocking material 530 may be injected into the capsule 520 in a liquid state through the opening 520a and then cured into a solid state. Accordingly, the internal space of the capsule 520 may be tightly filled with the blocking material 530 irrespective of the curvature, cross-sectional shape, and the like of the capsule 520. The blocking material 530 may include a high heat-resistant material, for example, at least one selected from silicone, epoxy, and polyurethane.

The second body 540 may be arranged to face the first body 510 and may form the other side exterior of the blocking member 500. The second body 540 may function as a component that covers the opening 520a of the capsule 520 and seals the capsule 520.

As an example, the second body 540 may be formed to have a plate shape. A lower surface of the second body 540 may be seated on the upper surface of the first body 510. The second body 540 may be made of a polymer compound material.

The first body 510 and the second body 540 may be joined to each other along a joint line 501. The joint line 501 may be an area in which the first body 510 and the second body 540 are physically joined to each other among the entire area of the first body 510 and the second body 540. The joint line 501 may be arranged to surround the opening 520a of the capsule 520. Accordingly, the first body 510 and the second body 540 are integrally coupled along a peripheral surface of the opening 520a, thereby preventing or reducing instances of the blocking material 530 located inside the capsule 520 flowing out through the opening 520a. The first body 510 and the second body 540 may be joined to each other through various types of coupling methods including friction welding, ultrasonic welding, bolting, fitting, and the like.

The blocking member 500 may further include an extension portion 550.

The extension portion 550 may extend from the first body 510 or the second body 540 and may support the fixing member 600 which will be described below.

The extension portion 550 according to some embodiments may extend from the second body 540 in the width direction of the housing 10, that is, a direction toward the terminal 320. The extension portion 550 may protrude to the outside of the first body 510, and a lower surface thereof may be arranged to face the upper surface of the cap plate 310.

A pair of extension portions 550 may be provided. The pair of extension portions 550 may be symmetrically arranged at both sides of the first body 510 and the second body 540. The pair of extension portions 550 may extend in opposite directions from the second body 540 to different terminals 320.

Although an example in which the extension portion 550 extends from the second body 540 has been described above, but embodiments according to the present disclosure are not limited thereto, and the extension portion 550 may also extend from the first body 510.

The fixing member 600 may function as a component for fixing the blocking member 500 to the cap plate 310.

The fixing member 600 may include a cap sheet 610.

The cap sheet 610 may be located between the extension portion 550 and the cap plate 310. Both surfaces of the cap sheet 610 may each be fixed to one of the lower surface of the extension portion 550 and the upper surface of the cap plate 310. As an example, the cap sheet 610 may be a double-sided tape with both sides coated with an adhesive material or an adhesive made of an adhesive material. A cross-sectional shape of the cap sheet 610 may be changed into various shapes such as a circular shape, an oval shape, and a polygonal shape in addition to a rectangular shape.

A pair of cap sheets 610 may be provided. The pair of cap sheets 610 may each be individually fixed to one of the extension portions 550.

A film may be attached to a lower surface of the cap sheet 610 which faces the cap plate 310. The film may function as a component that prevents or reduces instances of contaminants, foreign materials, or the like being attached to the lower surface of the cap sheet 610 in a state in which the cap sheet 610 is not fixed to the cap plate 310. The film may be removed from the cap sheet 610 before the cap sheet 610 is in contact with the cap plate 310.

The battery module according to some embodiments may further include a busbar holder 30.

The busbar holder 30 may be located inside the housing 10 and may function as a component that supports a busbar 31.

The busbar holder 30 according to some embodiments may be formed to have a plate shape. The busbar holder 30 may be arranged such that an upper surface faces the housing cover 12, and a lower surface faces an upper surface of the battery cell 20, that is, the cap plate 310. The busbar holder 30 may be formed to include an electrically insulating polymer compound material.

The busbar 31 may be electrically connected to the battery cell 20. The busbar 31 may be fixed to the busbar holder 30 through various types of coupling methods including welding, bolting, fitting, and the like. The busbar 31 may be in contact with the terminal 320 of the battery cell 20. The busbar 31 may include a conductive material such as aluminum, nickel, or copper to be electrically connectable to the terminal 320.

A plurality of busbars 31 may be provided. The plurality of busbars 31 may connect the plurality of battery cells 20 in series or parallel. The number and arrangement of the plurality of busbars 31 may be designed to be changed in various ways according to series and parallel connection structures of the battery cells 20.

Hereinafter, the configuration of a battery module according to some embodiments of the present disclosure will be described.

The battery module according to some embodiments of the present disclosure may be configured to differ only in the detailed configuration of the battery module, the blocking member 500, and the fixing member 600 according to some embodiments of the present disclosure described with reference to FIGS. 1 to 12.

Accordingly, in describing the battery module according to some embodiments, only the detailed configuration of the blocking member 500 and the fixing member 600, which are different from those of the battery module according to some embodiments of the present disclosure, will be described.

The description of the battery module according to some embodiments of the present disclosure may be equally applied to the remaining configuration of the battery module according to some embodiments.

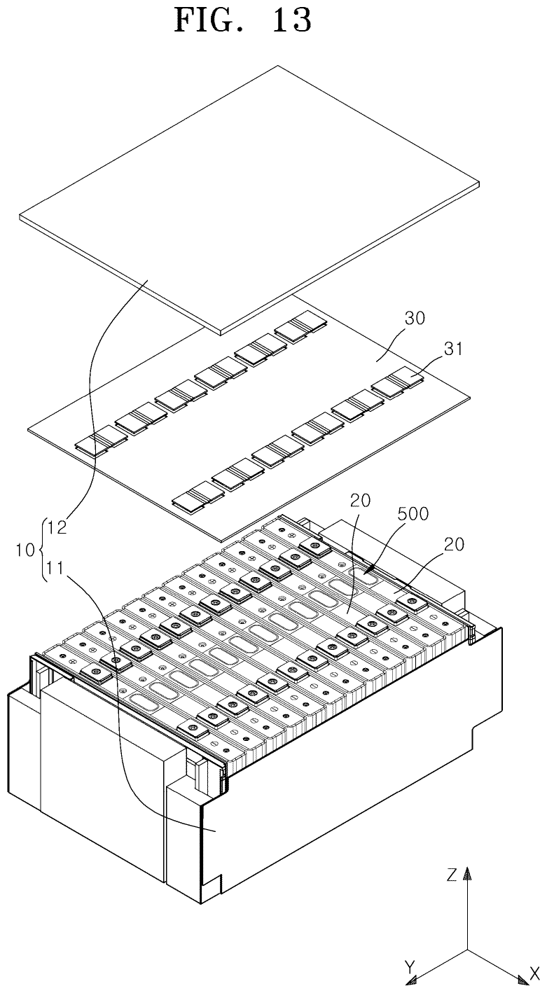

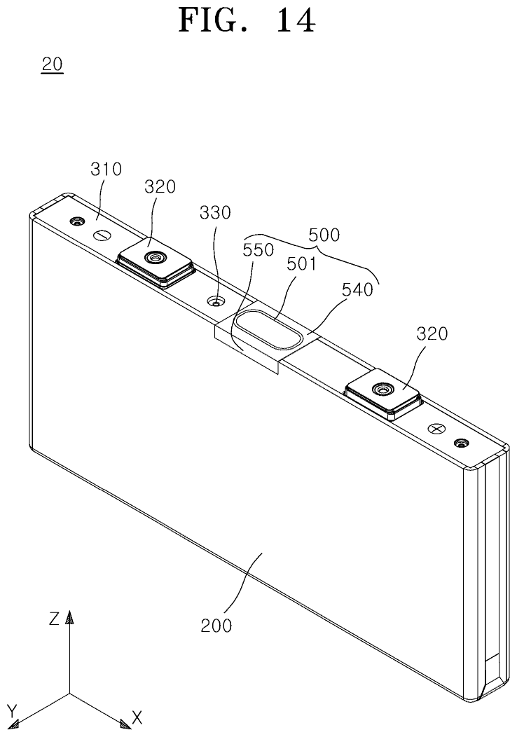

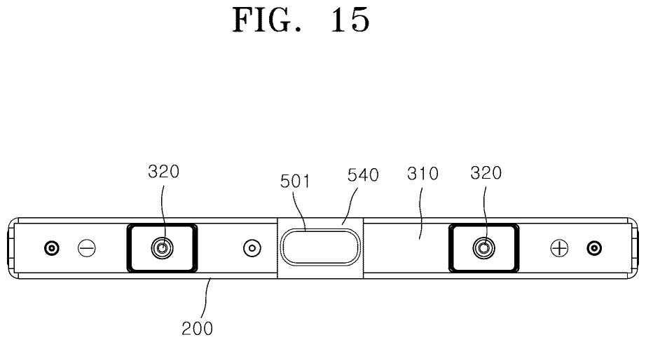

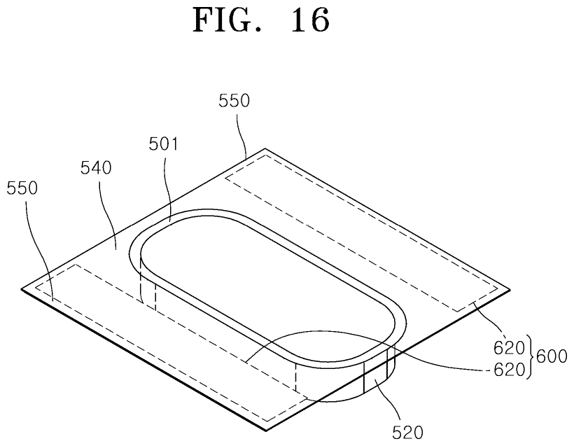

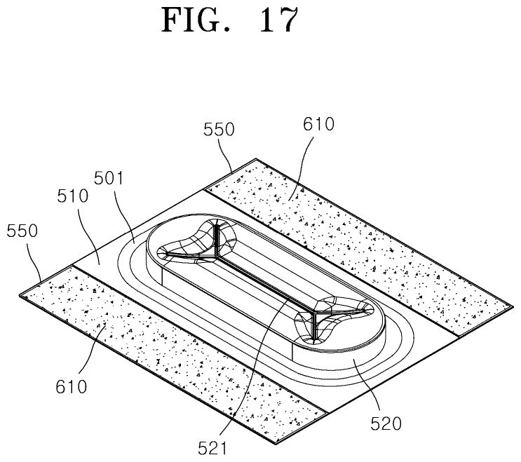

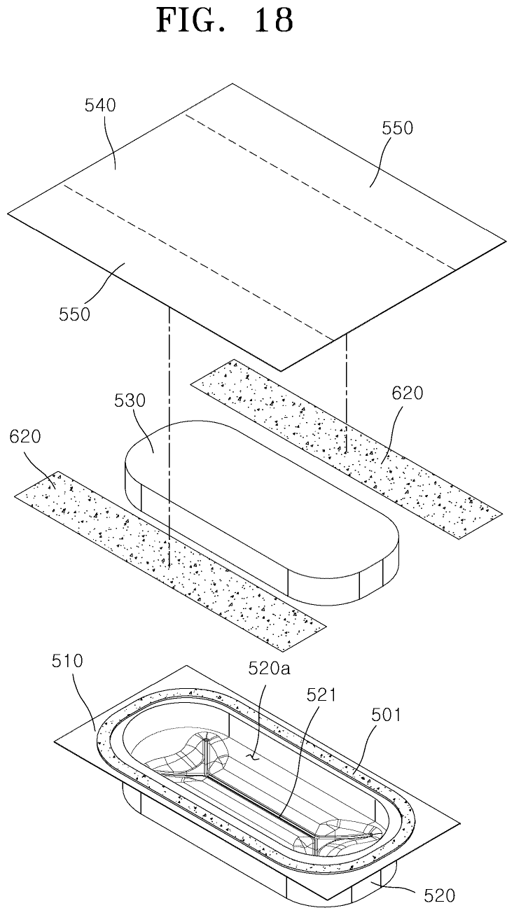

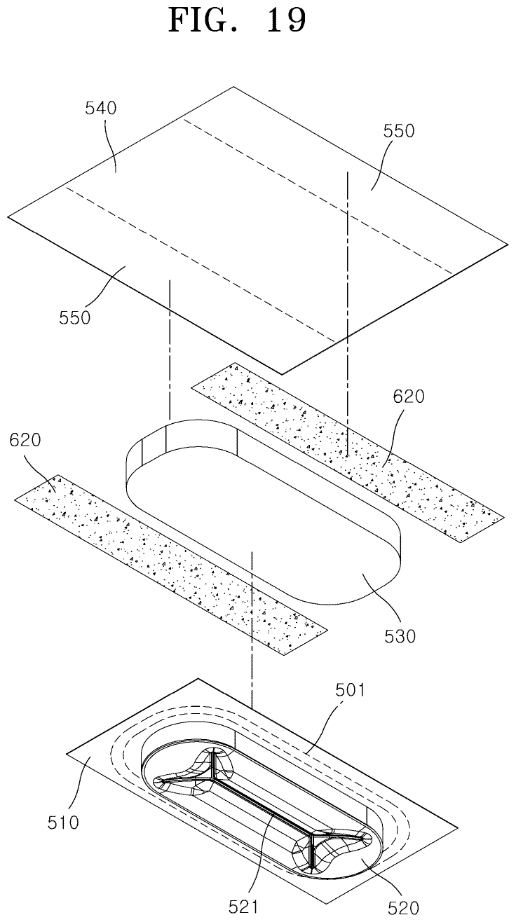

FIG. 13 is a schematic perspective view illustrating a configuration of a battery module according to some embodiments of the present disclosure. FIG. 14 is a schematic perspective view illustrating a configuration of a battery cell according to some embodiments of the present disclosure. FIG. 15 is a schematic plan view illustrating the configuration of the battery cell according to some embodiments of the present disclosure. FIG. 16 is a schematic perspective view illustrating a configuration of a blocking member and a fixing member according to some embodiments of the present disclosure. FIG. 17 is a perspective view illustrating the configuration of the blocking member and the fixing member according to some embodiments of the present disclosure from a viewpoint different from that of FIG. 16. FIG. 18 is a schematic exploded perspective view illustrating the configuration of the blocking member and the fixing member according to some embodiments of the present disclosure. FIG. 19 is an exploded perspective view illustrating the configuration of the blocking member and the fixing member according to some embodiments of the present disclosure from a viewpoint different from that of FIG. 18.

Referring to FIGS. 13 to 19, an extension portion 550 according to some embodiments may extend downward from an end of a second body 540 facing an adjacent battery cell 20. The extension portion 550 may be arranged to intersect a first body 510 and the second body 540. An inner surface of the extension portion 550 may be arranged to face an outer surface of a cell case 200.

The extension portion 550 may extend in a longitudinal direction of a housing 10, that is, a direction toward the adjacent battery cell 20, and then may be bent in a direction toward the cell case 200.

A pair of extension portions 550 may be provided. The pair of extension portions 550 may each extend from one of both ends of the second body 540 facing adjacent battery cells 20 and may be arranged to face different surfaces of the cell case 200.

Although an example in which the extension portion 550 extends from the second body 540 has been described above, but embodiments according to the present disclosure are not limited thereto, and the extension portion 550 may also extend from the first body 510.

The fixing member 600 according to some embodiments may function as a component for fixing the blocking member 500 to the cell case 200.

The fixing member 600 may include a case sheet 620.

The case sheet 620 may be located between the extension portion 550 and the cell case 200. Both surfaces of the cap sheet 610 may each be fixed to one of the inner surface of the extension portion 550 and an outer surface of the cell case 200. As an example, the case sheet 620 may be a double-sided tape with both sides coated with an adhesive material or an adhesive made of an adhesive material. A cross-sectional shape of the case sheet 620 may be changed into various shapes such as a circular shape, an oval shape, and a polygonal shape in addition to a rectangular shape.

A pair of case sheets 620 may be provided. The pair of case sheets 620 may each be individually fixed to one of the extension portions 550.

A film may be attached to an inner surface of the case sheet 620 which faces the cell case 200. The film may function as a component that prevents or reduce instances of contaminants, foreign materials, or the like being attached to the inner surface of the case sheet 620 in a state in which the case sheet 620 is not fixed to the cell case 200. The film may be removed from the case sheet 620 before the case sheet 620 is in contact with the cell case 200.

According to some embodiments of the present disclosure, when a fire occurs in any one battery cell, a blocking member covering a vent plate can prevent or reduce chain ignition of a plurality of battery cells due to flames, gases, smoke, or the like flowing into vent holes of adjacent battery cells.

According to the present disclosure, assembly can be relatively easier and the overall process time can be relatively shortened as compared to a method of directly applying a blocking material to a vent hole of a battery cell.

According to the present disclosure, a blocking material is installed in a battery cell in a state of being injected into a capsule in advance, thereby relatively reducing the complexity of handling chemicals.

According to the present disclosure, because a blocking member is individually installed for each battery cell, the blocking members installed in the corresponding battery cell and other battery cells may be prevented from being lifted during thermal runaway of any one battery cell.

However, the characteristics of embodiments according to the present disclosure are not limited to the above-described characteristics, and other characteristics that are not specifically mentioned will be clearly understood by those skilled in the art from the description of embodiments according to the present disclosure.

While aspects of some embodiments of the present disclosure have been described with reference to embodiments shown in the drawings, these embodiments are merely illustrative and it should be understood that various modifications and equivalent other embodiments can be derived by those skilled in the art on the basis of the embodiments.

Therefore, the scope of embodiments according to the present disclosure should be defined by the appended claims, and their equivalents.

What is claimed is:

1. A battery cell comprising:
an electrode assembly;
a cell case accommodating the electrode assembly;
a cap plate coupled to the cell case and having a vent hole;
a vent plate in the vent hole and configured to be opened or closed in response to an internal pressure of the cell case;
a blocking member facing the cap plate and covering the vent plate; and
a fixing member fixing the blocking member to the cell case or the cap plate.

2. The battery cell as claimed in claim 1, wherein the blocking member comprises:
a first body seated on the cap plate;
a capsule protruding from the first body and facing the vent plate;
a blocking material inside the capsule; and
a second body facing the first body and configured to seal the capsule.

3. The battery cell as claimed in claim 2, wherein the first body and the second body are joined to each other along a joint line to surround an opening of the capsule.

4. The battery cell as claimed in claim 2, wherein the blocking material is injected into the capsule in a liquid state and then cured.

5. The battery cell as claimed in claim 2, wherein the blocking material comprises at least one selected from silicone, epoxy, and polyurethane.

6. The battery cell as claimed in claim 2, wherein the capsule is inserted into the vent hole.

7. The battery cell as claimed in claim 6, wherein an edge of the capsule is curved.

8. The battery cell as claimed in claim 2, wherein the capsule contacts the vent plate.

9. The battery cell as claimed in claim 8, wherein the vent plate comprises a fracture portion which protrudes toward the vent hole and is configured to be fractured based on the internal pressure of the cell case rising to a set pressure or more, and
the capsule comprises a groove into which the fracture portion is inserted.

10. The battery cell as claimed in claim 2, wherein the blocking member further comprises an extension portion extending from the first body or the second body.

11. The battery cell as claimed in claim 10, wherein the extension portion is provided as a pair of extension portions, and
the pair of extension portions are symmetrically arranged at both sides of the first body or the second body.

12. The battery cell as claimed in claim 10, wherein the extension portion faces the cap plate, and
the fixing member comprises a cap sheet between the extension portion and the cap plate and having both surfaces fixed to the extension portion and the cap plate, respectively.

13. The battery cell as claimed in claim 10, wherein the extension portion faces the cell case, and
the fixing member comprises a case sheet between the extension portion and the cell case and having both surfaces fixed to the extension portion and the cell case, respectively.

14. The battery cell as claimed in claim 13, wherein the extension portion intersects the first body and the second body.

15. A battery module comprising:
a housing; and
one or more battery cells inside the housing,
wherein the battery cell comprises:
an electrode assembly;
a cell case accommodating the electrode assembly;
a cap plate coupled to the cell case and having a vent hole;
a vent plate installed in the vent hole and configured to be opened or closed in response to an internal pressure of the cell case;
a blocking member facing the cap plate and covering the vent plate; and
a fixing member configured to fix the blocking member to the cell case or the cap plate.
